(19) United States
(12) Patent Application Publication
(10) Pub. No.: US 2021/0348540 A1
(43) Pub. Date: Nov. 11, 2021

(54) SYSTEMS AND METHODS FOR MONITORING A TEMPERATURE OF AN EXHAUST AFTERTREATMENT SYSTEM

(71) Applicant: DENSO International America, Inc., Southfield, MI (US)

(72) Inventors: Edward SZCZEPANSKI, Grosse Pointe Farms, MI (US); William LEISMER, Madison Heights, MI (US)

(73) Assignee: DENSO International America, Inc., Southfield, MI (US)

(21) Appl. No.: 16/869,959

(22) Filed: May 8, 2020

(51) Int. Cl. F01N 9/00; F01N 3/20; B60K 6/24; B60K 6/26

(52) U.S. Cl. CPC F01N 9/00; F01N 3/2013; B60K 6/24; B60Y 2200/92; F01N 2550/22; F01N 2900/10; F01N 2900/1602; B60K 6/26

(57) ABSTRACT

A method includes providing electric power to an exhaust aftertreatment system component. The method includes obtaining an impedance value of the exhaust aftertreatment system component in response to providing the electric power. The method includes determining a temperature of the exhaust aftertreatment system component based on the impedance value. The method includes adjusting a magnitude of the electric power in response to the temperature of the exhaust aftertreatment system component satisfying one or more temperature metrics.

### FIELD

The present disclosure relates to systems and methods for monitoring a temperature of exhaust aftertreatment system components.

### BACKGROUND

The statements in this section merely provide background information related to the present disclosure and may not constitute prior art.

An internal combustion engine (ICE) of a vehicle typically includes an exhaust system to route or handle exhaust gas (i.e., combusted gases) expelled from one or more cylinders of the ICE. Furthermore, an exhaust aftertreatment system in communication with the ICE may reduce toxic gases and pollutants of the exhaust gas into less toxic pollutants by catalyzing a redox reaction.

The exhaust aftertreatment system may operate at various temperature ranges, and the temperature ranges may correlate to a propulsion mode of the vehicle. As an example, when the vehicle is in an electric propulsion mode, the exhaust aftertreatment system operates within a first temperature range. As another example, when the vehicle is in an ICE propulsion mode, the exhaust aftertreatment system may operate at a second temperature range that is greater than the first temperature range. Accordingly, the exhaust aftertreatment system may include one or more temperature sensors configured to obtain temperature data of the exhaust aftertreatment system.

### SUMMARY

This section provides a general summary of the disclosure and is not a comprehensive disclosure of its full scope or all of its features.

The disclosure provides a method that includes providing electric power to an exhaust aftertreatment system component. The method includes obtaining an impedance value of the exhaust aftertreatment system component in response to providing the electric power. The method includes determining a temperature of the exhaust aftertreatment system component based on the impedance value. The method includes adjusting a magnitude of the electric power in response to the temperature of the exhaust aftertreatment system component satisfying one or more temperature metrics.

The present disclosure provides a system that includes a processor and a nontransitory computer-readable medium including instructions that are executable by the processor. The instructions include providing electric power to an exhaust aftertreatment system component. The instructions include obtaining an impedance value of the exhaust aftertreatment system component in response to providing the electric power. The instructions include determining a temperature of the exhaust aftertreatment system component based on the impedance value. The instructions include adjusting a magnitude of the electric power in response to the temperature of the exhaust aftertreatment system component satisfying one or more temperature metrics.

The present disclosure also provides a vehicle that includes an electrically heated catalyst, a processor, and a nontransitory computer-readable medium including instructions that are executable by the processor. The instructions include providing electric power to the electrically heated catalyst. The instructions include obtaining an impedance value of the electrically heated catalyst in response to providing the electric power. The instructions include determining a temperature of the electrically heated catalyst based on the impedance value. The instructions include adjusting a magnitude of the electric power in response to the temperature of the electrically heated catalyst satisfying one or more temperature metrics.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A illustrates a vehicle according to the teachings of the present disclosure;

FIG. 1B is a catalytic converter according to the teachings of the present disclosure;

FIG. 1C is a particulate filter according to the teachings of the present disclosure;

FIG. 2A is a block diagram of a system for monitoring a temperature of an exhaust aftertreatment system according to the teachings of the present disclosure;

FIG. 2B is a block diagram illustrating various components of a switching module of the system of FIG. 2A according to the teachings of the present disclosure;

FIG. 3 illustrates graphs of the temperature of an exhaust aftertreatment system as a function of time, electrical power supplied to an exhaust aftertreatment system as a function of time, and the impedance of an exhaust aftertreatment system as a function of time according to the teachings of the present disclosure;

FIG. 4 is a flow chart for monitoring the impedance of an exhaust aftertreatment system according to the teachings of the present disclosure; and

FIG. 5 is a flow chart for monitoring the impedance of an exhaust aftertreatment system during the electric propulsion mode according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

A system for controlling and monitoring a temperature of a component (e.g., an electrically heated catalyst, a particulate filter, among others) in an exhaust aftertreatment system of an internal combustion engine (ICE) includes a power regulator module electrically coupled to the component. The power regulator module includes various modules that provide electric power applied to the component, obtain an impedance value of the component, determine a temperature of the component based on the impedance, and adjust the magnitude of the electric power applied to the component based on the temperature. By selectively adjusting the magnitude of the electric power applied to the component based on the impedance (and thus the temperature) of the component, the power regulator module can accurately control and monitor various temperatures for operating in various vehicle propulsion modes, such as an electric propulsion mode, a hybrid propulsion mode, and an ICE propulsion mode, without the use of or in conjunction with temperature sensors.

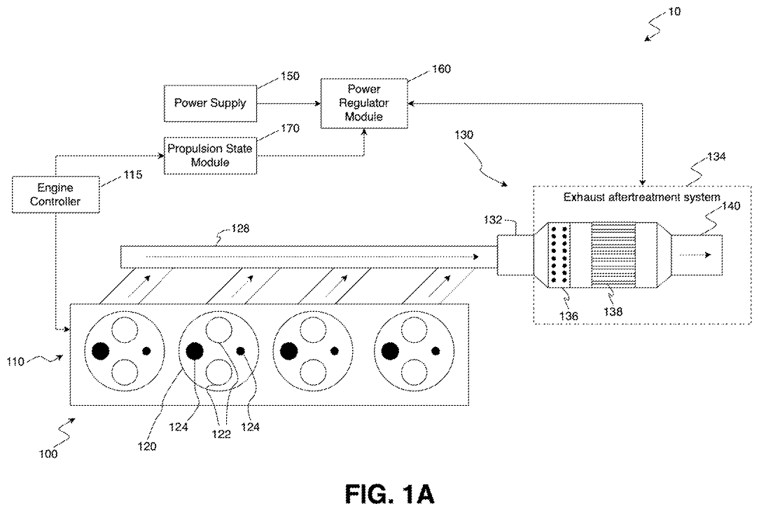

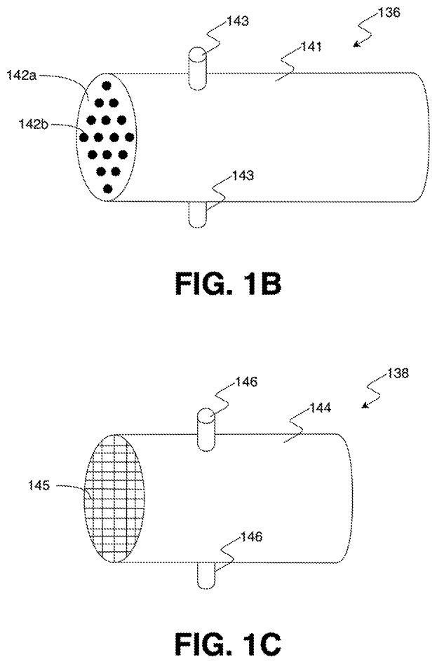

Referring to FIG. 1A, a vehicle 10 that controls and monitors a temperature of a component (e.g., an electrically heated catalyst, a particulate filter, among others) located therein is shown. In some forms, the vehicle 10 includes an ICE 100, an exhaust system 130, a power supply 150, a power regulator module 160, and a propulsion state module 170.

The ICE 100 includes an engine controller 115 and a cylinder bank 110 that includes a plurality of cylinders 120. Each cylinder 120 includes at least two valves 122 (e.g., an intake valve and an exhaust valve), a fuel injector 124, and a spark initiator 126 (e.g., a spark plug). A manifold 128 is in fluid communication with the cylinder bank 110.

The exhaust system 130 includes an exhaust pipe 132 and an exhaust aftertreatment system 134 with various components to filter exhaust gas flowing therethrough. As an example, the exhaust aftertreatment system 134 includes a catalytic converter 136 (e.g., a three-way catalytic (TWC) converter, an electrically heated catalytic (EHC) converter, among others) and a particulate filter 138 disposed downstream from the catalytic converter 136. While the particulate filter 138 and the catalytic converter 136 are shown as individual components, it should be understood that the particulate filter 138 may be integrated within the catalytic converter 136 in some variations.

With reference to FIG. 1B, an example illustration of the catalytic converter 136 is shown. In some forms, the catalytic converter 136 is an EHC converter that includes an electrically conductive portion 141, a substrate 142a, a catalyst material 142b disposed on and supported by the substrate 142a, and electrical leads 143. While two electrical leads 143 are shown, it should be understood that the catalytic converter 136 may include any number of electrical leads 143. In some forms, the electrically conductive portion 141 and the electrical leads 143 include an electrically conductive material that is suitable for operating at predefined temperatures, such as up to 650° C. As an example, the electrically conductive portion 141 and the electrical leads 143 include an electrically conductive material such as nickel, copper, chromium, molybdenum, tungsten, iron, aluminum, silicon, boron, an alloy thereof, among others. The electrically conductive portion 141 may surround the substrate 142a and the catalyst material 142b. For example, in some variations, the electrically conductive portion 141 is a metallic sheet surrounding the substrate 142a. In other variations, the electrically conductive portion 141 includes the electrically conductive material disposed on and/or within the substrate 142a such that an electrical current can flow from one portion or region of the catalytic converter 136 to another portion or region of the catalytic converter 136. In still other variations, the electrically conductive portion 141 can be one or more resistive heating elements disposed on and/or within the substrate 142a. In at least one variation, the substrate 142a is ceramic material with a honeycomb structure (e.g., a “brick”), and the catalyst material 142b can include platinum group metals (PGMs) disposed on the catalyst material 142b. For example, a washcoat containing PGMs can be applied to the substrate 142a. Accordingly, when the electrically conductive portion 141 receives electrical power from the power supply 150 via the power regulator module 160 and the electrical leads 143, the substrate 142a and/or the catalyst material 142b is heated, thereby enhancing the reduction of the nitrogen oxides (NOx) to nitrogen (N2), the oxidation of carbon monoxide (CO) to carbon dioxide (CO₂), and the oxidation of unburnt hydrocarbons (HC) into CO₂ and water (H₂O) from exhaust gas flowing through the catalytic converter 136, as described below in further detail.

With reference to FIG. 1C, an example illustration of the particulate filter 138 is shown. In some forms, the particulate filter 138 includes an electrically conductive portion 144, a filter element 145, and electrical leads 146. While two electrical leads 146 are shown, it should be understood that the particulate filter 138 may include any number of electrical leads 146. In some forms, the electrically conductive portion 144 and the electrical leads 146 include an electrically conductive material that is suitable for operating at predefined temperatures, such as up to 650° C. As an example, the electrically conductive portion 144 and the electrical leads 146f include a conductive material as described above. The electrically conductive portion 144 may surround the filter element 145. For example, and similar to the catalytic converter 136 describe above, in some variations, the electrically conductive portion 144 is a metallic sheet surrounding the filter element 145. In other variations, the electrically conductive portion 144 comprises the electrically conductive material disposed on and/or within the substrate filter element 145 such that an electrical current can flow from one portion or region of the particulate filter 138 to another portion or region of the particulate filter 138. Accordingly, when the electrically conductive portion 144 receives electrical power from the power supply 150 via the power regulator module 160 and the electrical leads 146, the filter element 145 is heated to assist in oxidation of particulate mass accumulated in the filter element 145, thereby increasing the efficiency of the ICE 100.

With reference to FIG. 1A, the power supply 150 is configured to provide electrical power to various components of the vehicle 10. As an example, the power supply 150 includes a direct current (DC) power source (e.g., a battery) configured to provide DC electrical power. As another example, the power supply 150 includes an alternating current (AC) power source and a rectifier circuit configured to provide the DC electrical power.

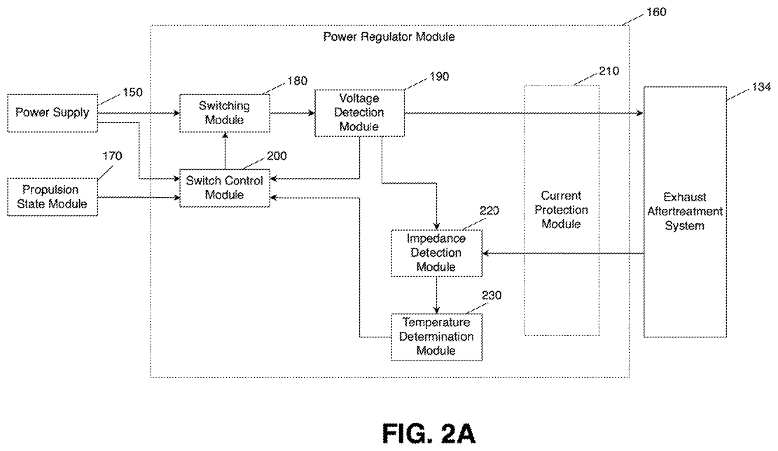

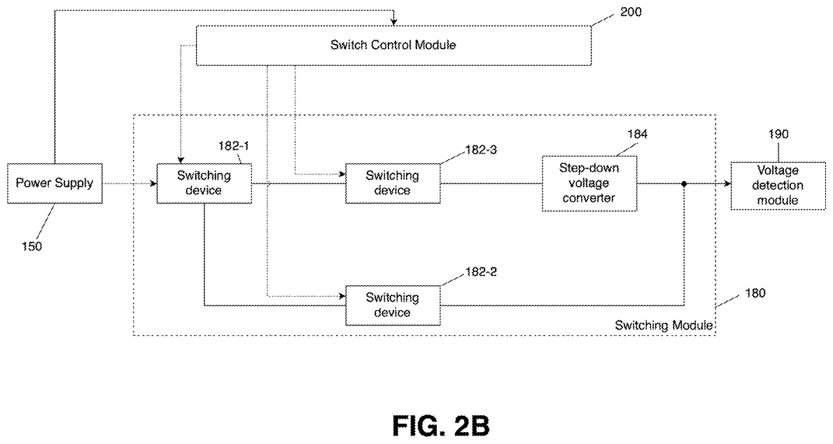

The power regulator module 160 includes one or more modules for monitoring an impedance of one or more components of the exhaust aftertreatment system 134. Additionally, the power regulator module 160 includes one or more modules for controlling a magnitude of the electrical power supplied to the one or more components of the exhaust aftertreatment system 134. The functionality of the power regulator module 160 is described below in further detail with reference to FIGS. 2A-2B.

The propulsion state module 170 is configured to provide propulsion state information associated with the vehicle 10. As an example, the propulsion state information may indicate that the vehicle 10 is in an electric propulsion mode, an ICE propulsion mode, or a hybrid propulsion mode (i.e., a combination of the electric propulsion mode and the ICE propulsion mode). During the electric propulsion mode, the power supply 150 (and other power electronics systems not shown) generates the propulsion forces to drive (i.e., power or move) the vehicle 10. During the ICE propulsion mode, the ICE 100 generates the propulsion forces to drive the vehicle 10. During the hybrid propulsion mode, the power supply 150 and the ICE 100 generate the propulsion forces to drive the vehicle.

During operation of the vehicle 10 in the ICE propulsion mode or the hybrid propulsion mode, the engine controller 115 directs fuel via the fuel injectors 124 and air via the valves 122 (i.e., intake valves) into each of the cylinders 120. The engine controller 115 also directs firing of each of the spark initiators 126 such that the fuel plus air mixture in each cylinder 120 is combusted and expelled from the cylinders 120 via the valves 122 (i.e., exhaust valves) as exhaust gas (not labeled). The exhaust gas expelled from the cylinders 120 flows through the manifold 128, the exhaust pipe 132, the catalytic converter 136, and the particulate filter 138, and the exhaust gas exits the exhaust system 130 at outlet 140. As the exhaust gas flows through the exhaust system 130, the catalytic converter 136 provides reduction of NOx to N2, oxidation of CO to CO₂, and oxidation of unburnt HC into CO₂ and H₂O (collectively referred to as treatment of exhaust gas flow). To provide the treatment of the exhaust gas flow, the catalytic converter 136 may be supplied with electric power from the power supply 150 via the power regulator module 160 such that the temperature of the catalytic converter 136 is greater than an average lightoff threshold temperature (e.g., 465° C.) and less than a maximum operating temperature (e.g., 650° C.), as described below in further detail. As used herein, the “lightoff temperature” refers to a temperature in which catalytic reactions are initiated with the catalytic converter 136.

During operation of the vehicle 10 in the electric propulsion mode, the ICE 100 is deactivated, as the vehicle 10 is propelled by the electrical power from the power supply 150. Accordingly, no exhaust gas flow is directed through the exhaust aftertreatment system 134. However, to facilitate transitions between various propulsion modes (e.g., from the electric propulsion mode to the ICE mode or hybrid propulsion mode), the catalytic converter 136 may be supplied with electric power from the power supply 150 via the power regulator module 160 such that the temperature of the catalytic converter 136 (i.e., the substrate 142a and/or catalyst material 142b ) is greater than a minimum lightoff threshold temperature (e.g., 450° C.) and less than a maximum lightoff threshold temperature (e.g., 475° C.) during the electric propulsion mode, as described below in further detail.

Referring to FIGS. 2A-2B, an example functional block diagram of the power regulator module 160 is shown. The power regulator module 160 may include a switching module 180, a voltage detection module 190, a switch control module 200, a current protection module 210, an impedance detection module 220, and a temperature determination module 230. In some forms, at least a portion of the power regulator module 160 is located on a microcontroller that includes a processor configured to execute instructions stored in a nontransitory computer-readable medium, such as a random-access memory (RAM) and/or a read-only memory (ROM). In other forms, at least a portion of the power regulator module 160 is communicatively coupled to an external microcontroller that includes a processor configured to execute instructions stored in a nontransitory computer-readable medium, such as a RAM and/or ROM.

The switching module 180 is configured to receive the electrical power from the power supply 150 and output a pulse width modulated (PWM) signal. As shown in FIG. 2B, the switching module 180 may include a plurality of switching devices 182-1, 182-2, 182-3, (collectively referred to as switching devices 182) and a step-down voltage converter 184. Switching device 182-1 and switching device 182-2 form a first electrical loop. Switching device 182-1, switching device 182-3, and the step-down voltage converter 184 form a second electrical loop. In some forms, the switching devices 182 may be at least one of a bipolar junction transistor (BJT), an insulated gate bipolar transistor (IGBT), a metal-oxide semiconductor field-effect transistor (MOSFET), and/or the like. The step-down voltage converter 184 may be various fixed or variable DC-to-DC voltage converters, such as a buck converter, a voltage regulator integrated circuit, and/or the like. The operation of the switching devices 182 may be controlled by the switch control module 200, as described below in further detail.

The voltage detection module 190 is configured to detect a voltage magnitude of the PWM signal output by the switching module 180. As an example, the voltage detection module 190 may include one or more resistors that form a voltage divider with the switching module 180 and/or the switch control module 200, an operational amplifier configured to detect the voltage magnitude, an integrated circuit configured to detect the voltage magnitude, an analog-to-digital converter (ADC) configured to output a digital signal representing the voltage magnitude, among others. The voltage magnitude may be provided to the switch control module 200, which subsequently controls the operation of the switching devices 182 based on the voltage magnitude, as described below in further detail.

The switch control module 200 is configured to control the operation of the switching devices 182 based on at least one of the voltage magnitude as determined by the voltage detection module 190, the propulsion mode information provided by the propulsion state module 170, and the temperature of the component of the exhaust aftertreatment system 134 as determined by the temperature determination module 230. To control the operation of the switching devices 182, the switch control module 200 is configured to selectively provide a biasing voltage to the switching devices 182 (as indicated by the dotted arrows of FIG. 2B), thereby activating or deactivating the switching devices 182 and/or the step-down voltage converter 184. Furthermore, the switch control module 200 may include an additional step-down voltage converter to convert the voltage magnitude of the electrical signal received from the power supply 150 to the biasing voltage magnitude.

The current protection module 210 is configured to limit the amount of current provided to the component of the exhaust aftertreatment system 134 when the power regulator module 160 is activated (e.g., turned on) and during steady-state operation of the power regulator module 160. Likewise, the current protection module 210 is configured to limit the amount of reverse current provided to the power regulator module 160 when the power regulator module 160 is deactivated (e.g., turned off). In some forms, the current protection module 210 may include a fuse, a thermistor, a network of transistors and/or diodes, an integrated circuit that provides active and resettable overcurrent protection, among others.

The impedance detection module 220 is configured to generate a signal indicating the impedance value of the component of the exhaust aftertreatment system 134 when the component receives electrical power from the power regulator module 160. The impedance detection module 220 may include various combinations of passive or active electronic components used to indicate the impedance value of the component of the exhaust aftertreatment system 134. As an example, the impedance detection module 220 may include one or more resistors electrically coupled to the component of the exhaust aftertreatment system 134 such that a voltage divider circuit is formed. Based on the known resistance of the one or more resistors, the voltage magnitude of the PWM signal as determined by the voltage detection module 190, and a voltage magnitude of a common node of the one or more resistors and the component of the exhaust aftertreatment system 134, the impedance detection module 220 is configured to generate the signal indicating the resistance of the component of the exhaust aftertreatment system 134. As another example, the impedance detection module 220 may include a resistor-capacitor (RC) network, a resistor-inductor (RL) network, or a resistor-capacitor-inductor (RLC) network electrically coupled to the component of the exhaust aftertreatment system 134 such that a voltage divider circuit is formed. Based on the known reactance of the RC network, RL network, or RLC network, the voltage magnitude of the PWM signal as determined by the voltage detection module 190, and a voltage magnitude of a common node of one of the RC network, RL network, or RLC network and the component of the exhaust aftertreatment system 134, the impedance detection module 220 is configured to generate the signal indicating the reactance of the component of the exhaust aftertreatment system 134.

The temperature determination module 230 is configured to determine the temperature of the component of the exhaust aftertreatment system 134 based on the impedance value received from the impedance detection module 220. In some forms, the temperature determination module 230 determines the temperature by referencing a lookup table that correlates various impedance value with a corresponding temperature.

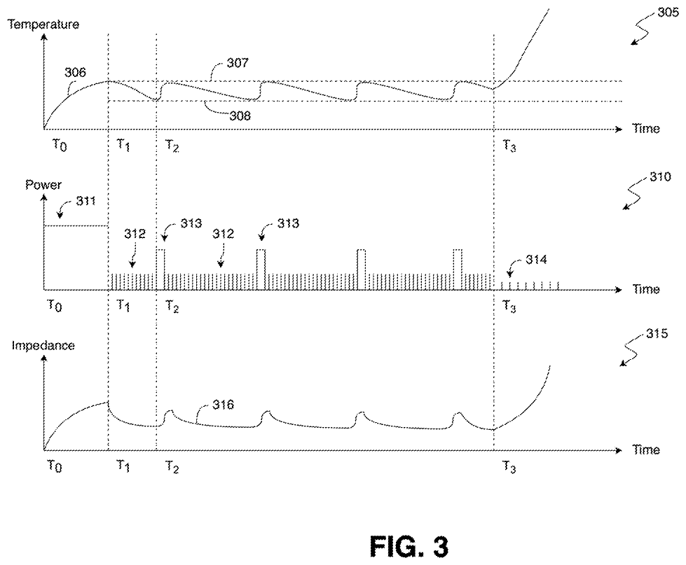

Referring to FIGS. 1, 2A-2B and 3, the operation of the power regulator module 160 and exhaust aftertreatment system 134 will now be provided. Particularly, FIG. 3 shows a temperature graph 305 for the temperature versus time of the component of the exhaust aftertreatment system 134 (e.g., the catalytic converter 136), a power graph 310 for the power versus time output by the power regulator module 160 (e.g., power applied to the electrically conductive portion 144), and an impedance graph 315 for the impedance versus time of the component of the exhaust aftertreatment system 134 (e.g., the impedance of the catalytic converter 136). Also, when the vehicle 10 is turned on, as indicated by To in temperature graph 305, electric power graph 310, and impedance graph 315, the vehicle 10 may be set to one of the electric propulsion mode, the hybrid propulsion mode, and the ICE propulsion mode. When the vehicle 10 is set to the electric propulsion mode, the power regulator module 160 is configured to output an electrical signal to the component of the exhaust aftertreatment system 134 such that the temperature of the component, as indicated by temperature curve 306 (graph 305) and based on the corresponding impedance curve 316 (graph 315), is less than or equal to a maximum light-off temperature threshold 307 and greater than or equal to a minimum light-off temperature threshold 308.

As an example, when the vehicle 10 is turned on at T₀, the switch control module 200 may selectively activate switching devices 182 such that power signal 311 (graph 310) is provided to the component of the exhaust aftertreatment system 134 (e.g., switching devices 182-1, 182-2, 182-3 are always on from T₀ to T₁ or switching devices 182-1, 182-2, 182-3 are turned on and off from T₀ to T₁ such that the power signal 311 has a predefined pulse width and/or amplitude, among others).

Once the temperature of the component of the exhaust aftertreatment system 134 reaches the maximum light-off temperature threshold 307 at T₁, the power regulator module 160 decreases at least one of the pulse width and an amplitude of the signal provided to the component of the exhaust aftertreatment system 134. In some forms, the switch control module 200 may selectively activate switching devices 182 such that temperature reduction signal 312 is provided to the component of the exhaust aftertreatment system 134. As an example, to generate the temperature reduction signal 312 at T₁, the switch control module 200 may deactivate switching device 182-2 (which was activated at T₀) and selectively activate switching devices 182-1, 182-3 to reduce the pulse width and the pulse amplitude. By providing the temperature reduction signal 312, the temperature of the component of the exhaust aftertreatment system 134 is reduced and inhibited from exceeding the maximum light-off temperature threshold 307.

Once the temperature of the component of the exhaust aftertreatment system 134 reaches the minimum light-off temperature threshold 308 at T₂, the power regulator module 160 increases at least one of the pulse width and an amplitude of the signal provided to the component of the exhaust aftertreatment system 134. In some forms, the switch control module 200 may selectively activate switching devices 182 such that burst signal 313 is provided to the component of the exhaust aftertreatment system 134. As an example, to generate the burst signal 313 at T₂, the switch control module 200 may selectively activate switching devices 182-1, 182-2, 182-3 to increase the pulse width and the pulse amplitude. By providing the burst signal 313, the temperature of the component of the exhaust aftertreatment system 134 is increased and inhibited from falling below the minimum light-off temperature threshold 308.

As illustrated in the temperature graph 305 and the electric power graph 310, during the electric propulsion mode, the temperature reduction signal 312 and the burst signal 313 are selectively applied to the component of the exhaust aftertreatment system 134 such that the temperature of the component of the exhaust aftertreatment system 134 is less than or equal to a maximum light-off temperature threshold 307 and greater than or equal to a minimum light-off temperature threshold 308.

When a torque request signal received by the propulsion state module 170 indicates that the vehicle 10 is switched from the electric propulsion mode to one of the hybrid propulsion mode and the ICE propulsion mode at T₃, exhaust gas is provided to the exhaust aftertreatment system 134, thereby increasing the temperature of the component of the exhaust aftertreatment system 134. Accordingly, the power regulator module 160 may decrease at least one of the pulse width and an amplitude of the signal provided to the component of the exhaust aftertreatment system 134 when the vehicle 10 is in one of the hybrid propulsion mode and the ICE propulsion mode. In some forms, the switch control module 200 may selectively activate switching devices 182 such that temperature assist/monitoring signal 314 is provided to the component of the exhaust aftertreatment system 134. As an example, to generate the temperature assist/monitoring signal 314 at T₃, the switch control module 200 may deactivate switching devices 182-2 and selectively activate switching devices 182-1, 182-3 to reduce the pulse width and the pulse amplitude.

In some forms, when the vehicle 10 is set from the electric propulsion mode to one of the hybrid propulsion mode and the ICE propulsion mode, the power regulator module 160 may discontinue supplying electrical power to the component of the exhaust aftertreatment system 134. Accordingly, to discontinue supplying electrical power, the switch control module 200 may deactivate each of the switching devices 182 of the switching module 180.

Referring to FIGS. 1, 2A-2B, 3, and 4, an example routine 400 is shown. At 404, the vehicle 10 is set to the electric propulsion mode when, for example, the vehicle 10 is turned on. At 408, the vehicle 10 performs an electric mode impedance detection routine, which includes selectively outputting the power signal 311, the temperature reduction signal 312, or the burst signal 313 based on the temperature of the component of the exhaust aftertreatment system 134, as described above. At 412, the vehicle 10 determines whether a torque request signal indicates that the activation of the ICE 100 is required (i.e., the torque request signal indicates a switch from the electric propulsion mode to one of the hybrid propulsion mode and the ICE propulsion mode). If the torque request signal indicates that the activation of the ICE 100 is required, the vehicle 10 is set to one of the hybrid propulsion mode and the ICE propulsion mode at 416. Conversely, the routine 400 proceeds to 408 if the torque request signal indicates that the activation of the ICE 100 is not required.

At 420, the vehicle 10 performs a non-electric mode impedance detection routine, which includes outputting the temperature assist/monitoring signal 314 or discontinuing the supply of electrical power to the component of the exhaust aftertreatment system 134, as described above. At 424, the vehicle 10 determines whether a torque request signal indicates that the ICE 100 is required. If the torque request signal indicates that the ICE 100 is required, the routine 400 proceeds to 420; otherwise, the routine 400 proceeds to 404.

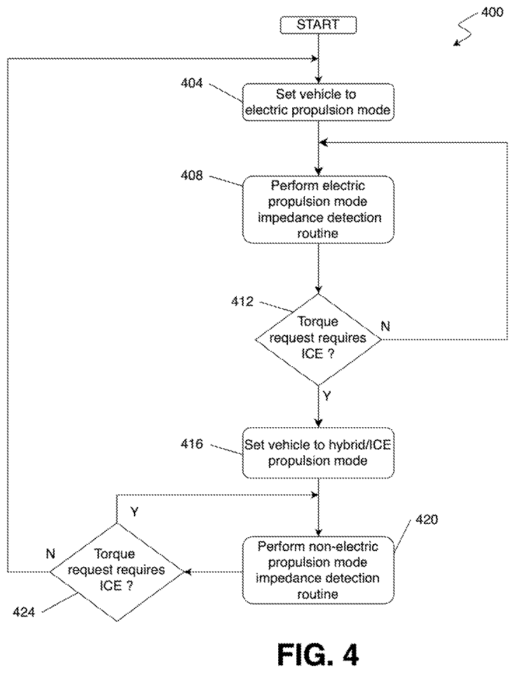

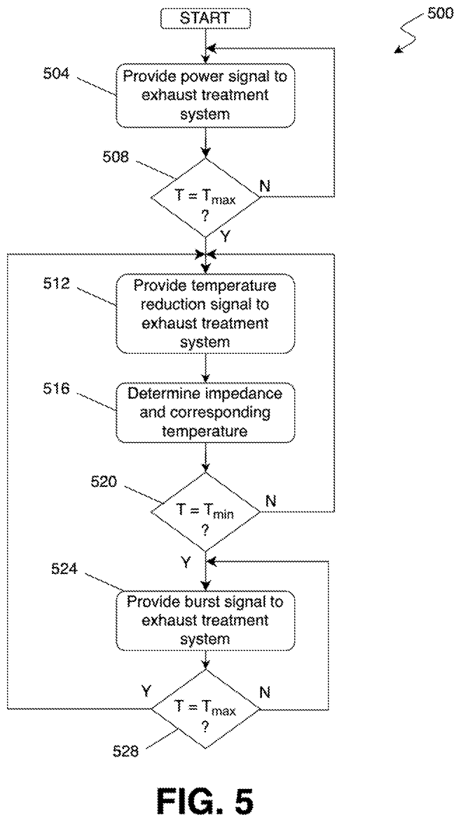

Referring to FIGS. 1, 2A-2B, 3, and 4-5, an example routine 500 is shown. The routine 500 represents an example routine for performing the electric mode impedance detection routine described at step 408 of FIG. 4. At 504, the power regulator module 160 provides the power signal 311 to the component of the exhaust aftertreatment system 134. At 508, the power regulator module 160 determines whether the temperature is equal to the maximum light-off temperature threshold 307. If the temperature is equal to the maximum light-off temperature threshold 307, the routine 500 proceeds to 512; otherwise, the routine 500 proceeds to 504.

At 512, the power regulator module 160 provides the temperature reduction signal 312 to the component of the exhaust aftertreatment system 134. At 516, the power regulator module 160 determines the impedance and the corresponding temperature of the component of the exhaust aftertreatment system 134. At 520, the power regulator module 160 determines whether the temperature is equal to the minimum light-off temperature threshold 308. If the temperature is equal to the minimum light-off temperature threshold 308, the routine 500 proceeds to 524; otherwise, the routine 500 proceeds to 512.

At 524, the power regulator module 160 provides the burst signal 313 to the component of the exhaust aftertreatment system 134. At 528, the power regulator module 160 determines whether the temperature is equal to the maximum light-off temperature threshold 307. If the temperature is equal to the maximum light-off temperature threshold 307, the routine 500 proceeds to 512; otherwise, the routine 500 proceeds to 524.

It should be understood that while the routine 500 is depicted a continuous loop, the routine 500 may end when a torque request requires the activation of the ICE 100, as described above in FIG. 4. It should also be understood that routines 400, 500 are merely example control routines and other control routines may be implemented.

By using the power regulator module 160 described herein to control and monitor a temperature of a component of the exhaust aftertreatment system 134, the power regulator module 160 can accurately control the temperature of the component of the exhaust aftertreatment system 134 without using temperature sensors and while operating in various vehicle propulsion modes, such as the electric propulsion mode, the hybrid propulsion mode, and the ICE propulsion mode. In this manner, an electrically heated catalytic converter can be heated during operation of the vehicle 10 while operating in the electric propulsion mode such that switching operation of the vehicle 10 to the hybrid propulsion mode or the ICE propulsion mode results in desired treatment of exhaust gas flowing through the exhaust aftertreatment system 134. That is, less than desired reduction of NOx to N₂, oxidation of CO to CO₂, and/or oxidation of unburnt HC into CO₂ and H₂O from exhaust gas flowing through the catalytic converter 136 is inhibited or prevented.

Based on the foregoing, the following provides a general overview of the present disclosure and is not a comprehensive summary.

In some forms of the present disclosure, the temperature of the exhaust aftertreatment system component satisfies the one or more temperature metrics when the temperature of the exhaust aftertreatment system component is greater than or equal to a maximum light-off temperature threshold. In some forms, adjusting the magnitude of the electric power in response to the temperature of the exhaust aftertreatment system component satisfying the one or more temperature metrics further includes decreasing at least one of a pulse width of the electric power and an amplitude of the electric power.

In some forms of the present disclosure, the temperature of the exhaust aftertreatment system component satisfies the one or more temperature metrics when the temperature of the exhaust aftertreatment system component is equal to a minimum light-off temperature threshold. In some forms, adjusting the magnitude of the electric power in response to the temperature of the exhaust aftertreatment system component satisfying the one or more temperature metrics further includes increasing at least one of a pulse width of the electric power and an amplitude of the electric power.

In some forms of the present disclosure, the method further includes receiving a torque request signal indicating a request to activate an internal combustion engine. The method further includes adjusting the magnitude of the electric power in response to receiving the torque request signal, where adjusting the magnitude of the electric power further includes decreasing at least one of a pulse width of the electric power and an amplitude of the electric power.

In some forms of the present disclosure, obtaining the impedance value of the exhaust aftertreatment system component in response to providing the electric power further includes: obtaining an impedance value from an impedance detection circuit in response to providing the electric power, where the impedance detection circuit is electrically coupled to the exhaust aftertreatment system component; and determining the impedance value of the exhaust aftertreatment system component based on the impedance value of the impedance detection circuit.

In some forms of the present disclosure, the impedance detection circuit and the exhaust aftertreatment system component are electrically coupled to form a voltage divider circuit.

In some forms of the present disclosure, providing the electric power to the exhaust aftertreatment system component further includes: determining a propulsion mode, where the propulsion mode includes at least one of an electric propulsion mode and an internal combustion engine propulsion mode, providing a first signal having a first power value in response to determining the propulsion mode is the electric propulsion mode, and providing a second signal having a second power value in response to determining the propulsion mode is the internal combustion engine propulsion mode.

In some forms of the present disclosure, the exhaust aftertreatment system component is an electrically heated catalyst.

In some forms of the present disclosure, providing the electric power to the exhaust aftertreatment system component further includes selectively activating one or more switches of a switching circuit, where the switching circuit electrically couples the exhaust aftertreatment system component and a power supply.

In some forms of the present disclosure, the temperature of the exhaust aftertreatment system component satisfies the one or more temperature metrics when the temperature of the exhaust aftertreatment system component is greater than or equal to a maximum light-off temperature threshold. In some forms, the instructions for adjusting the magnitude of the electric power in response to the temperature of the exhaust aftertreatment system component satisfying the one or more temperature metrics further include decreasing at least one of a pulse width of the electric power and an amplitude of the electric power.

In some forms of the present disclosure, the temperature of the exhaust aftertreatment system component satisfies the one or more temperature metrics when the temperature of the exhaust aftertreatment system component is equal to a minimum light-off temperature threshold. In some forms, the instructions for adjusting the magnitude of the electric power in response to the temperature of the exhaust aftertreatment system component satisfying the one or more temperature metrics further include increasing at least one of a pulse width of the electric power and an amplitude of the electric power.

In some forms of the present disclosure, the instructions further include receiving a torque request signal indicating a request to activate an internal combustion engine, and adjusting the magnitude of the electric power in response to the torque request signal, where adjusting the magnitude of the electric power further includes decreasing at least one of a pulse width of the electric power and an amplitude of the electric power.

In some forms of the present disclosure, the instructions for obtaining the impedance value of the exhaust aftertreatment system component in response to providing the electric power further include: obtaining an impedance value from an impedance detection circuit in response to providing the electric power, where the impedance detection circuit is electrically coupled to the exhaust aftertreatment system component, and determining the impedance value of the exhaust aftertreatment system component based on the impedance value of the impedance detection circuit.

In some forms of the present disclosure, the impedance detection circuit and the exhaust aftertreatment system component are electrically coupled to form a voltage divider circuit.

In some forms of the present disclosure, the instructions for providing the electric power to the exhaust aftertreatment system component further include: determining a propulsion mode, where the propulsion mode includes at least one of an electric propulsion mode and an internal combustion engine propulsion mode, providing a first signal having a first power value in response to determining the propulsion mode is the electric propulsion mode, and providing a second signal having a second power value in response to determining the propulsion mode is the internal combustion engine propulsion mode.

In some forms of the present disclosure, the first power value is greater than the second power value.

In some forms of the present disclosure, the instructions for providing the electric power to the exhaust aftertreatment system component further include selectively activating one or more switches of a switching circuit, where the switching circuit electrically couples the exhaust aftertreatment system component and a power supply.

In some forms of the present disclosure, the temperature of the electrically heated catalyst satisfies the one or more temperature metrics when at least one of: the temperature of the electrically heated catalyst is greater than or equal to a maximum light-off temperature threshold, and the temperature of the electrically heated catalyst is less than a minimum light-off temperature threshold.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, manufacturing technology, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, the term “module” and/or “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and nontransitory. Non-limiting examples of a nontransitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

1. A method comprising:
determining an amplitude of electric power and a pulse width of the electric power based on a propulsion mode of a vehicle, wherein the propulsion mode comprises one of an electric propulsion mode and an internal combustion engine propulsion mode;
providing the electric power to an exhaust aftertreatment system component based on the amplitude and the pulse width;
obtaining an impedance value of the exhaust aftertreatment system component in response to providing the electric power;
determining a temperature of the exhaust aftertreatment system component based on the impedance value;
adjusting at least one of the amplitude and the pulse width of the electric power in response to the temperature of the exhaust aftertreatment system component satisfying one or more temperature metrics; and
decreasing at least one of the amplitude and the pulse width of the electric power to provide a temperature monitoring signal having a first pulse width and a first amplitude when the vehicle is set from the electric propulsion mode to the internal combustion engine propulsion mode, wherein the first pulse width is greater than zero, and wherein the first amplitude is greater than zero.

2. The method of claim 1, wherein:
the temperature of the exhaust aftertreatment system component satisfies the one or more temperature metrics when the temperature of the exhaust aftertreatment system component is greater than or equal to a maximum light-off temperature threshold; and
adjusting at least one of the amplitude and the pulse width of the electric power in response to the temperature of the exhaust aftertreatment system component satisfying the one or more temperature metrics further comprises decreasing at least one of the pulse width of the electric power and the amplitude of the electric power.

3. The method of claim 1, wherein:
the temperature of the exhaust aftertreatment system component satisfies the one or more temperature metrics when the temperature of the exhaust aftertreatment system component is equal to a minimum light-off temperature threshold; and
adjusting at least one of the amplitude and the pulse width of the electric power in response to the temperature of the exhaust aftertreatment system component satisfying the one or more temperature metrics further comprises increasing at least one of the pulse width of the electric power and the amplitude of the electric power.

4. The method of claim 1 further comprising:
receiving a torque request signal indicating a request to activate an internal combustion engine; and
decreasing at least one of the pulse width of the electric power and the amplitude of the electric power.

5. The method of claim 1, wherein obtaining the impedance value of the exhaust aftertreatment system component in response to providing the electric power further comprises:
obtaining an impedance value from an impedance detection circuit in response to providing the electric power, wherein the impedance detection circuit is electrically coupled to the exhaust aftertreatment system component; and
determining the impedance value of the exhaust aftertreatment system component based on the impedance value of the impedance detection circuit.

6. The method of claim 5, wherein the impedance detection circuit and the exhaust aftertreatment system component are electrically coupled to form a voltage divider circuit.

7. The method of claim 1, wherein providing the electric power to the exhaust aftertreatment system component further comprises:
providing a first signal having a first power value in response to determining the propulsion mode is the electric propulsion mode; and
providing a second signal having a second power value in response to determining the propulsion mode is the internal combustion engine propulsion mode, wherein the first power value is greater than the second power value, and wherein the second power value is greater than zero.

8. The method of claim 1, wherein the exhaust aftertreatment system component is an electrically heated catalyst.

9. The method of claim 1, wherein providing the electric power to the exhaust aftertreatment system component further comprises selectively activating one or more switches of a switching circuit, wherein the switching circuit electrically couples the exhaust aftertreatment system component and a power supply.

10. A system comprising:
a processor; and
a nontransitory computer-readable medium comprising instructions that are executable by the processor, wherein the instructions comprise:
determining an amplitude of electric power and a pulse width of the electric power based on a propulsion mode of a vehicle, wherein the propulsion mode comprises one of an electric propulsion mode and an internal combustion engine propulsion mode;
providing the electric power to an exhaust aftertreatment system component based on the amplitude and the pulse width;
obtaining an impedance value of the exhaust aftertreatment system component in response to providing the electric power;
determining a temperature of the exhaust aftertreatment system component based on the impedance value;
adjusting at least one of the amplitude and the pulse width of the electric power in response to the temperature of the exhaust aftertreatment system component satisfying one or more temperature metrics; and
decreasing at least one of the amplitude and the pulse width of the electric power to provide a temperature monitoring signal having a first pulse width and a first amplitude when the vehicle is set from the electric propulsion mode to the internal combustion engine propulsion mode, wherein the first pulse width is greater than zero, and wherein the first amplitude is greater than zero.

11. The system of claim 10, wherein:
the temperature of the exhaust aftertreatment system component satisfies the one or more temperature metrics when the temperature of the exhaust aftertreatment system component is greater than or equal to a maximum light-off temperature threshold; and
the instructions for adjusting at least one of the amplitude and the pulse width of the electric power in response to the temperature of the exhaust aftertreatment system component satisfying the one or more temperature metrics further comprise decreasing at least one of the pulse width of the electric power and the amplitude of the electric power.

12. The system of claim 10, wherein:
the temperature of the exhaust aftertreatment system component satisfies the one or more temperature metrics when the temperature of the exhaust aftertreatment system component is equal to a minimum light-off temperature threshold; and
the instructions for adjusting at least one of the amplitude and the pulse width of the electric power in response to the temperature of the exhaust aftertreatment system component satisfying the one or more temperature metrics further comprise increasing at least one of the pulse width of the electric power and the amplitude of the electric power.

13. The system of claim 10, wherein the instructions further comprise:
receiving a torque request signal indicating a request to activate an internal combustion engine; and
decreasing at least one of the pulse width of the electric power and the amplitude of the electric power.

14. The system of claim 10, wherein the instructions for obtaining the impedance value of the exhaust aftertreatment system component in response to providing the electric power further comprise:
obtaining an impedance value from an impedance detection circuit in response to providing the electric power, wherein the impedance detection circuit is electrically coupled to the exhaust aftertreatment system component; and
determining the impedance value of the exhaust aftertreatment system component based on the impedance value of the impedance detection circuit.

15. The system of claim 14, wherein the impedance detection circuit and the exhaust aftertreatment system component are electrically coupled to form a voltage divider circuit.

16. The system of claim 10, wherein the instructions for providing the electric power to the exhaust aftertreatment system component further comprise:
providing a first signal having a first power value in response to determining the propulsion mode is the electric propulsion mode; and
providing a second signal having a second power value in response to determining the propulsion mode is the internal combustion engine propulsion mode, wherein the first power value is greater than the second power value, and wherein the second power value is greater than zero.

17. The system of claim 16, wherein the first power value is greater than the second power value.

18. The system of claim 10, wherein the instructions for providing the electric power to the exhaust aftertreatment system component further comprise selectively activating one or more switches of a switching circuit, wherein the switching circuit electrically couples the exhaust aftertreatment system component and a power supply.

19. A vehicle comprising:
an electrically heated catalyst;
a processor; and
a nontransitory computer-readable medium comprising instructions that are executable by the processor, wherein the instructions comprise:
determining an amplitude of electric power and a pulse width of the electric power based on a propulsion mode of a vehicle, wherein the propulsion mode comprises one of an electric propulsion mode and an internal combustion engine propulsion mode;
providing the electric power to an exhaust aftertreatment system component based on the amplitude and the pulse width;
obtaining an impedance value of the exhaust aftertreatment system component in response to providing the electric power;
determining a temperature of the exhaust aftertreatment system component based on the impedance value;
adjusting at least one of the amplitude and the pulse width of the electric power in response to the temperature of the exhaust aftertreatment system component satisfying one or more temperature metrics; and
decreasing at least one of the amplitude and the pulse width of the electric power to provide a temperature monitoring signal having a first pulse width and a first amplitude when the vehicle is set from the electric propulsion mode to the internal combustion engine propulsion mode, wherein the first pulse width is greater than zero, and wherein the first amplitude is greater than zero.

20. The vehicle of claim 19, wherein the temperature of the electrically heated catalyst satisfies the one or more temperature metrics when at least one of:
the temperature of the electrically heated catalyst is greater than or equal to a maximum light-off temperature threshold; and
the temperature of the electrically heated catalyst is less than a minimum light-off temperature threshold.
